(19) United States
(12) Patent Application Publication
(10) Pub. No.: US 2009/0226050 A1
(43) Pub. Date: Sep. 10, 2009

(54) System and apparatus for securing an item using a biometric lock

(76) Inventor: Michael L. Hughes, Los Angeles, CA (US)

Correspondence Address: MICHAEL HUGHES, 600 S. CURSON AVE, APT. 631, LOS ANGELES, CA, 90036, US

(21) Appl. No.: 12/075,063

(22) Filed: Mar. 6, 2008

(51) Int. Cl. G06K 9/00

(52) U.S. Cl. 382/124

(57) ABSTRACT

A system and apparatus for securing an item using a biometric lock where a matching fingerprint allows a user access to the item secured. In one embodiment, the item is a container with an aperture. More specifically, the container is a handbag, luggage, briefcase, computer bag, storage container, shipping container or gun holster. In one embodiment, the biometric lock apparatus is self contained and is applied to the item being secured. More specifically, the self contained biometric lock is a padlock, bicycle lock, or an independent lock with a shackle applied to an item. In one embodiment, the biometric lock is divided into multiple components, one component being a biometric key containing a sensor where a user inserts the key into another component of the lock and applies a finger to the sensor to read a matching fingerprint and unlock the mechanism. In one embodiment, the systems and apparatuses include utilizing an unlocking apparatus that contains a generator whereby the swiping of a fingerprint over a sensor simultaneously moves a thumb roller which activates the generator to power the device, and a fingerprint is initially installed through the use of an external computer and a secondary power source.

### BACKGROUND OF THE INVENTION

1. Field of the Invention

The present invention relates generally to a biometric lock apparatus and additionally relates to a system for securing an item which can be accessed through the use of a matching fingerprint. For the benefit of explanation, one embodiment of this invention would be used in securing a handbag, however can also be used in other embodiments as depicted in the detailed description.

The designer handbag industry has experienced double digit growth periods over the past decade. With the emergence of monogram handbags, consumers are no longer buying a handbag but rather are buying a social status symbol. Furthermore, with the recent opening of China to trade policies with international brands, luxury handbag designers are positioned for future growth explosions that have no end in sight. With such promising success however comes an industry of culprits designing counterfeit handbags in an attempt to ride on the heels of the legitimate brands. The counterfeit industry is a $600 billion global business with 5% contributed by counterfeit luxury items. Luxury brands are facing unprecedented challenges as counterfeiters are producing replicas with quality as good as, if not better than some originals. Designer handbag manufacturers desperately need a solution to thwart counterfeiters, and are just beginning to look to technology for anti-counterfeiting solutions.

Additionally, as present times are often referred to as the post 9-11 era, and social figureheads such as teachers and priests are being convicted for unthinkable acts, consumers are realizing that simple trust and social innocence is fading and are constantly questioning their security and the security of their possessions in ways which have never been questioned in the past. Companies who cater specifically to these concerns and use technology to provide added security to items which consumers deem as extremely personal or valuable have a unique opportunity to enhance consumers' quality of life and capture an ever-growing market.

2. Description of the Related Art

Including Information Disclosed Under 37 CFR 1.97 and 1.98

Of background interest is U.S. Pat. No. 6,876,756; CONTAINER SECURITY SYSTEM, where VIEWEG teaches of a container security system comprising a container with a first section and a second section; a touchpad for fingerprint identification attached to the outside of the first section; a sensor with at least one pre-stored fingerprint operatively coupled to the touchpad; a solenoid coupled to the sensor having a plunger reciprocable from a rest position to a withdrawn position in response to a signal from the sensor; a latch attached to the remote end of the plunger having recess therein; and a release assembly coupled to the second section with a finger removably positionable in the recess to maintain the container locked in a closed orientation but with the finger being readily removably from the recess to allow the container to assume an open orientation when the latch and the plunger are reciprocated in response to a fingerprint of a user on the touch pad matching a pre-stored fingerprint in the sensor.

The vast differences to the present invention will be further depicted in the detailed description hereunder, however the essential differences are as follows:

In the referenced patent, VIEWEG teaches of sensors as intelligent devices capable of storing and comparing fingerprint data. In the present invention, a sensor is a passive device only capable of providing a signal.

In the referenced patent, VIEWEG refers to the term touch pad, which seems to be used in the place of what would be typically referred to as a sensor. The touch pad specifically implies in claims 1, 2 & 3 by the phrase “adapted to generate a signal when a fingerprint of the user on the touch pad”, that the entire print is present on the touch pad at the same instant in time.

VIEWEG's notion of functionality is further supported by the description of the plunger operation in claims 1, 2 & 3 “having a plunger reciprocable from a rest position to a withdrawn position in response to a signal from the sensor so long as a fingerprint of a user is on the touch pad which matches a pre-stored fingerprint in the sensor”.

In several embodiments of the present invention, the sensor used is a swipe sensor, which does not function within this description. Further, a swipe sensor is superior to VIEWEG's design in that no latent print is left on the pad to be copied using aerosol, chemical or thermal imaging techniques to allow a duplicate false finger print to be created for unauthorized access. The swipe action destroys all but the tail end of a previously presented fingerprint.

In the referenced patent, VIEWEG refers to a solenoid coupled to the sensor having a plunger reciprocable from a rest position to a withdrawn position in response to a signal from the sensor. In several embodiments of the present invention, the solenoid is replaced by a magnetic clutch which is a different device since a solenoid generates motion powered by an external electrical source while a magnetic clutch simply couples the power of motion of a device to a mechanical load using an electrical signal. It does not provide sufficient power to actually generate the motion itself.

In the referenced patent, VIEWEG refers to a plunger as reciprocable from a rest position to a withdrawn position in response to a signal from the sensor. Plungers move in straight lines as suggested by their “reciprocation” with the “latch”. In the present invention, the motion is a rotary motion of a curved hook around a center pivot,

In the referenced patent, VIEWEG teaches of a sensor with at least one pre-stored fingerprint, which insinuates the device does not function unless a fingerprint is pre-stored. This is severely limiting from a marketing perspective as the lock and bag cannot open unless a fingerprint is first stored. Furthermore, the design provides a loophole to counterfeiters who manufacture counterfeits which do not require a pre-stored fingerprint to function.

In the referenced patent, VIEWEG teaches of multiple bag types containing a first part and a second part which are moveable relative to each other. The drawings depict a purse having a flap which is inserted, the suitcase and attache case drawings depict hard clamshell halves. The handbag has a fold over flap and the attache case has a button and employs a time delayed release hold on the plunger. None of them depict a zipper design. It is apparent from the drawings that no consideration was given to this type of embodiment.

In the referenced patent, VIEWEG teaches of a lock which is “level triggered”, in that the level of the signal from the fingerprint opens the lock and immediate removal would cause it to self relock except in the case of the attache case or claim 9 where a supplemental button and timer are used. In these exceptions the time delay would need to also expire before the self-relock would occur, which is still considered as level triggered. This is implied by VIEWEG's phrase “so long as a fingerprint of a user is on the touch pad”, which is used directly or indirectly in every claim. The present invention is “edge triggered” in that once the release signal is detected the position of the lock changes from one that is stable closed to one that is stable open. In the stable open position, fingerprint signals have no effect. To lock the device in the present invention, one must manually push it back shut.

Additionally, VIEWEG does not teach of several components which are critical to functionality; fingerprint enrollment, fingerprint processing means, and source of current. These components are critical to the functionality of the invention, and are components not readily known to one skilled in the art. To develop a fingerprint comparison process which uses minimal speed and processing power, to develop a durable power source strong enough to power the device (strong enough to power an alarm signal which remains on until a matching fingerprint is provided as taught by VIEWIG), yet small enough to fit within the device and a fingerprint enrollment process that allows a user to enroll a fingerprint externally without compromising security before the device will function would require a great deal of additional inventing, and is not referenced in VIEWEG's patent.

Also of background interest is U.S. Pat. No. 6,980,672 (Saito) titled Lock and Switch Using Pressure-Type Fingerprint Sensor. Also of background interest is U.S. Pat. No. 6,536,812 (Winardi) titled Adjustable-Backset Latch System For Locksets, And Method. Also of background interest is application #20040083782 (Lantz) titled Security Container Lock With Tamper-Evident Seal. Also of background interest is application #20060266563 (Kaplan) titled Carrying Case with Integrated Electronics System.

All the aforementioned patents and applications have similar differences to those mentioned, which confirms and validates the uniqueness of the present invention.

### SUMMARY OF THE INVENTION

A system and apparatus for securing an item using a biometric lock where a matching fingerprint allows a user access to the item secured. In one embodiment, the item is a container with an aperture. More specifically, the container is a handbag, luggage, briefcase, computer bag, storage container, shipping container or gun holster. In one embodiment, the biometric lock apparatus is self contained and is applied to the item being secured. More specifically, the self contained biometric lock is a padlock, bicycle lock, or an independent lock with a shackle applied to an item. In one embodiment, the biometric lock is divided into multiple components, one component being a biometric key containing a sensor where a user inserts the key into another component of the lock and applies a finger to the sensor to read a matching fingerprint and unlock the mechanism. In one embodiment, the systems and apparatuses include utilizing an unlocking apparatus that contains a generator whereby the swiping of a fingerprint over a sensor simultaneously moves a thumb roller which activates the generator to power the device, and a fingerprint is initially installed through the use of an external computer and a secondary power source.

### BRIEF DESCRIPTION OF THE DRAWINGS

This invention may be embodied in the form illustrated in the accompanying drawings, attention being called to the fact, however, that the drawings are illustrative only, and that changes may be made in the specific construction illustrated.

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 depicts a first embodiment of a biometric lock mechanism for a zippered handbag.

FIG. 2a depicts a zipper lock in the unlocked and nearly locked position.

FIG. 2b depicts a zipper lock in the locked position.

FIG. 2c depicts a zipper lock in the clutch-actuated, unlocking position.

FIG. 3a depicts the escutcheon plate of the biometric lock mechanism, comprising a fingerprint scanner, thumb roller and LED indicator.

FIG. 3b depicts a view of an arrangement of magnets beneath the surface of the thumb roller of 3a,

FIG. 3c depicts the generator mechanism and magnetic clutch of the biometric lock mechanism beneath the arrangement of magnets of FIG. 3b.

FIG. 4a depicts the armature of the generator mechanism of FIG. 3c.

FIG. 4b depicts the generator winding on the armature of FIG. 4a.

FIG. 4c depicts a side view of the generator winding on the armature of FIG. 4a.

FIG. 5a depicts the latch trip actuator of the biometric lock mechanism of FIG. 3c in the rest position.

FIG. 5b depicts the motion of movement of the latch trip actuator of FIG. 3c.

FIG. 5c depicts the latch trip actuator of the biometric lock mechanism of FIG. 3c in the actuated position.

FIG. 6 depicts an embodiment where the latch trip actuator is replaced by a solenoid in the latch box.

FIGS. 7a-7b depict a biometric lock mechanism on a handbag with a fold over flap closure.

FIG. 8 depicts a close up view of the biometric lock mechanism on a double zippered luggage

FIG. 9 depicts a method of opening a biometric lock

FIGS. 10a-10b depict a method of enrolling a user's fingerprint.

FIG. 11 depicts a method for enrolling a fingerprint for a new item by an established customer.

FIGS. 12a-12b depict the biometric lock mechanism in multiple components, comprising the locking mechanism and a biometric key.

### DETAILED DESCRIPTION OF THE INVENTION

Turning now descriptively to the drawings, in which similar reference characters denote similar elements throughout several views, the attached figures illustrate various embodiments of a biometric lock apparatus used in a system for securing an item.

In this respect, before explaining at least one embodiment of the invention in detail, it is to be understood that the invention is not limited in its application to the details of the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

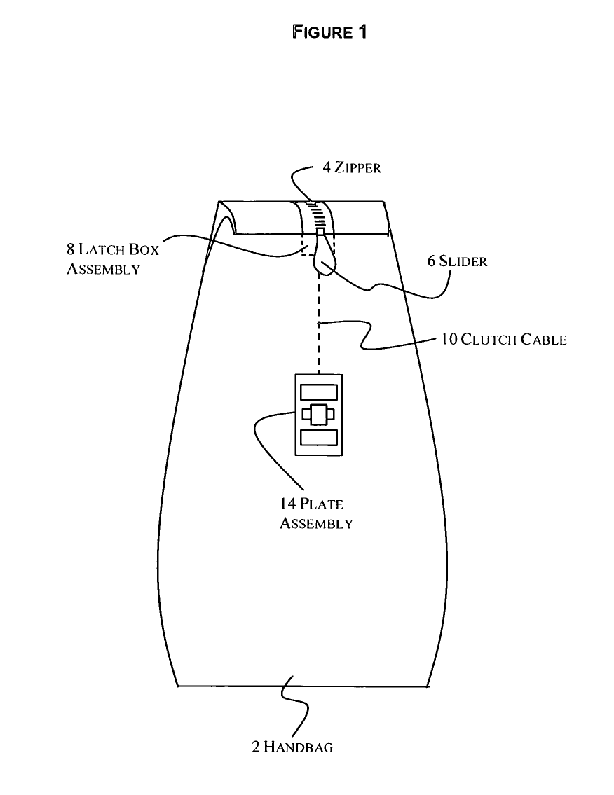

FIG. 1. Depicts an aerial view of a handbag, in one embodiment of the present invention. The handbag 2 containing a zipper 4 and slider 6 which secures and provides access to an aperture in the handbag 2. As discussed more fully below, a latch box assembly 8 is secured at the closed end of the zipper 4 and is operatively associated with the slider 6 as discussed below. A cable 10 connects the latch box assembly 8 to an unlocking mechanism 12 located about the handbag 2. A plate assembly 14 of the unlocking mechanism 12 is externally visible, which is discussed more fully below.

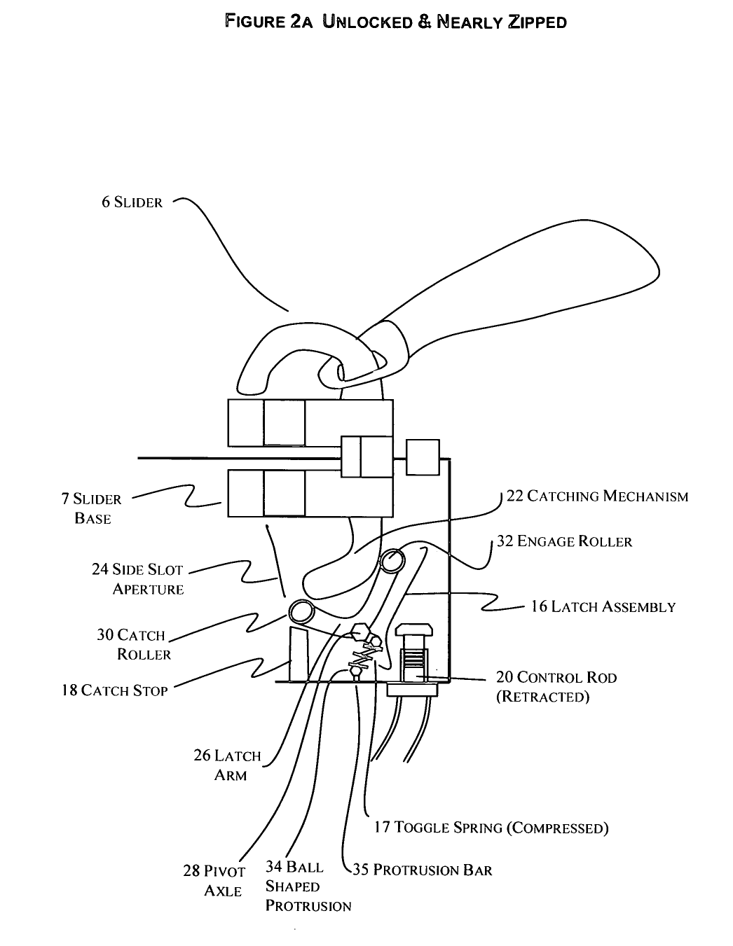

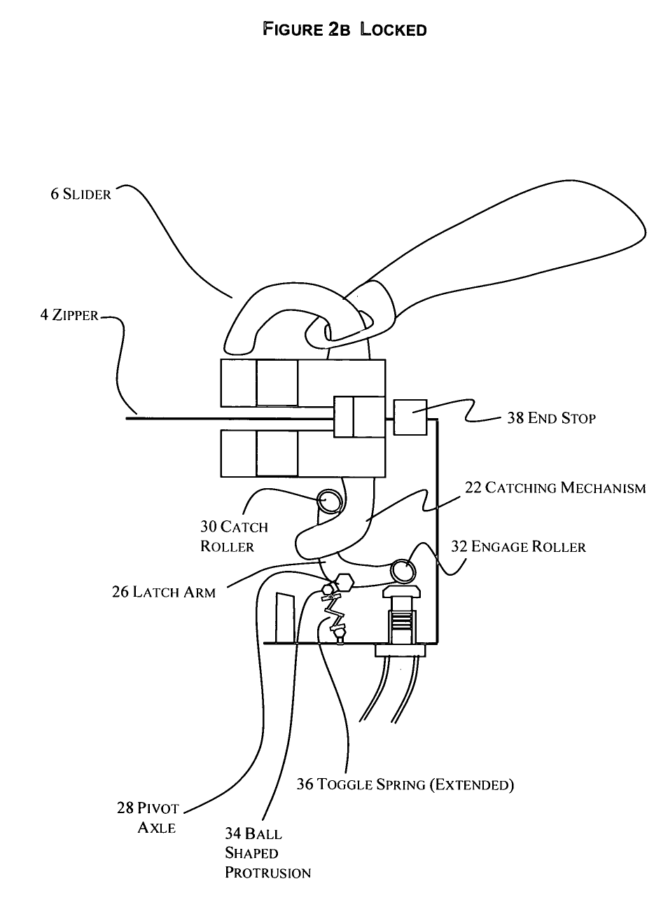

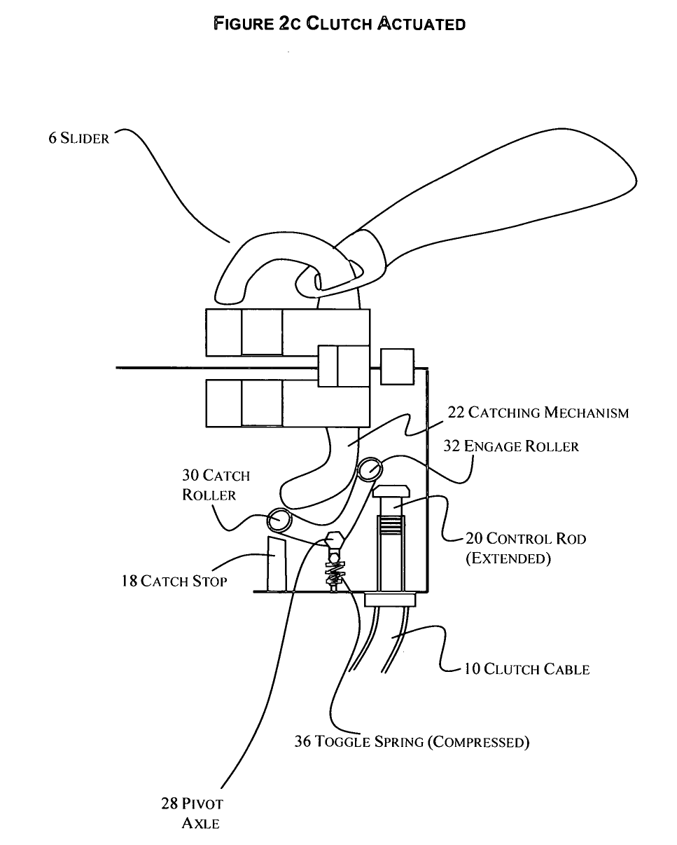

FIG. 2a depicts a side view of the slider 6 approaching the latch box assembly 8, which contains a latch assembly 16, catch stop 18, and a control rod 20 which is at the end of the clutch cable 10. A catching mechanism 22, such as a hook which opens away from the closing direction of slider 6, is operatively coupled to the base 7 of the slider 6. In one embodiment, the latch box assembly 8 contains a side slot aperture 24 adjacent to the closed end of the zipper 4, which receives the catching mechanism 22 of the slider 6 when zipped closed. In one embodiment, the latch box assembly 8 is operatively coupled to the base 7 of the slider 6 and a catching mechanism 22 is operatively coupled adjacent to the closed end of the zipper 4.

The latch arm 26 of the latch assembly 16 is a slightly curved bar, concave upward, which runs parallel to the catching mechanism 22 of the slider 6. In one embodiment, the latch arm 26 has a horizontally transverse pivot axle 28 through its midpoint supported by the sidewalls of the latch box assembly 8. The latch arm 26 is configured to pivot such that the catch roller 28 and engage roller 30 mounted on either end of the latch arm 26 are tipped into the path of the catching mechanism 22 of the slider 6.

A ball shaped protrusion 34 connected to a bar 35 on the bottom of the latch arm 26 directly below the pivot axle 28, which is pointing down and a similar protrusion 34 and bar 35 directly below it on the interior bottom surface of the latch box assembly 8, which is pointing up capture a toggle spring 36 between them. The inside diameter of the spring coils is large enough to allow approximately ⅓ of the ball protrusion 34 to enter the coil. The length of the protrusion causes the ball 34 on the bar 35 to move behind the pivot axle 28 when the catch roller 30 is tipped into the slider 6 path. The ball 34 moves beyond the pivot axle 28 (pivot center) when the engage roller 32 is tipped up into the path of the slider 6. This spring 36 makes the latch arm 26 unstable at the point were neither roller 30, 32 is in the path of the slider catch mechanism 22, so one end or the other is assured to block the catch mechanism's 22 progress. When the zipper 4 is opened, the latch arm 26 is stably positioned catch roller down 30, engage roller 32 up.

FIG. 2b depicts a side view of the slider 6 in the completely closed position, where the catching mechanism 22 of the slider 6 engages the latch arm 26 of the latch assembly 16.

Zipping the slider 6 closed will cause the catching mechanism 22 to pass over the catch roller 30 until it bumps into the engage roller 32. This will push the engage roller 32 down and out of the way of the catching mechanism 22 travel, compressing the spring 36. At the point where the ball protrusion 34 compressing the spring 36 passes directly under the center of the pivot axle 28, the spring 36 will be free to decompress on the opposite side of the pivot axle 28, pivoting the catch roller 30 up behind the catching mechanism 22 blocking it's exit such that pulling back on the slider 6 will move the catching mechanism 22 under the catch roller 30 and tip it until the line between the latch arm pivot axle 28 and the catch roller 30 center is pointing directly at the point of rest on the catching mechanism 22. This angle is not sufficient to tip the toggle spring ball protrusion 34 to the other side of the pivot axle 28. Thus when the slider 6 is released the spring 36 will drive the slider 6 back to full closed position. The handbag 2 is locked and tugging on the slider 6 will not release it from the latch arm 26.

The end stop 38 of the zipper 4 is positioned to limit the range of motion of the slider 6, and is configured such that the catching mechanism 22 of the slider 6 is fully engaged with the latch arm 26 when in the completely closed position.

FIG. 2c depicts a side view of the slider 6 in the process of being unlocked. Under the down position of the engage roller 32 is the lock release control rod 20. When the magnetic clutch 70 is actuated it pushes the clutch cable 10 to extend the control rod 20 up on the engage roller 32 side of the latch arm 26, which compresses and toggles the spring 36 to the other side of the pivot axle 28 which pivots the catch roller 30 down clearing the path of the catching mechanism 22. The latch arm 26 remains in a stable open position, with the engage roller 32 continuing to push against the catching mechanism 22 until removed by a user pulling on the slider 6 to unzip the handbag 2. In one embodiment, the force of the engage roller 32 engaging the catching mechanism 22 thrusts the catching mechanism 22 out of reach of the catch roller 30. In one embodiment a pulling force pulls the catching mechanism 22 out of reach of the catch roller 30 once the catch roller 30 clears the path of the catching mechanism 22. The shift of force in the toggle spring 36 maintains the latch arm 26 in the open position after the control rod 20 recedes and after the slider 6 is removed from the closed position. The latch arm 26 maintains a stable open position until the catch mechanism 22 of the slider 6 contacts the engage roller 32, as depicted in FIG. 2a.

A catch stop 18 is operatively positioned below the catch roller 30 in the open position to limit the range of motion of the latch arm 26 such that the catching mechanism 22 can clear the catch roller 30 when unlocking. While the embodiment of the present invention is of a zipper release, the latch release mechanism 22 may be applied to other closure or lock types, particularly those closure or lock types for which momentary application of pressure unlocks, such as for use with locks where the disclosed control rod 20 functions.

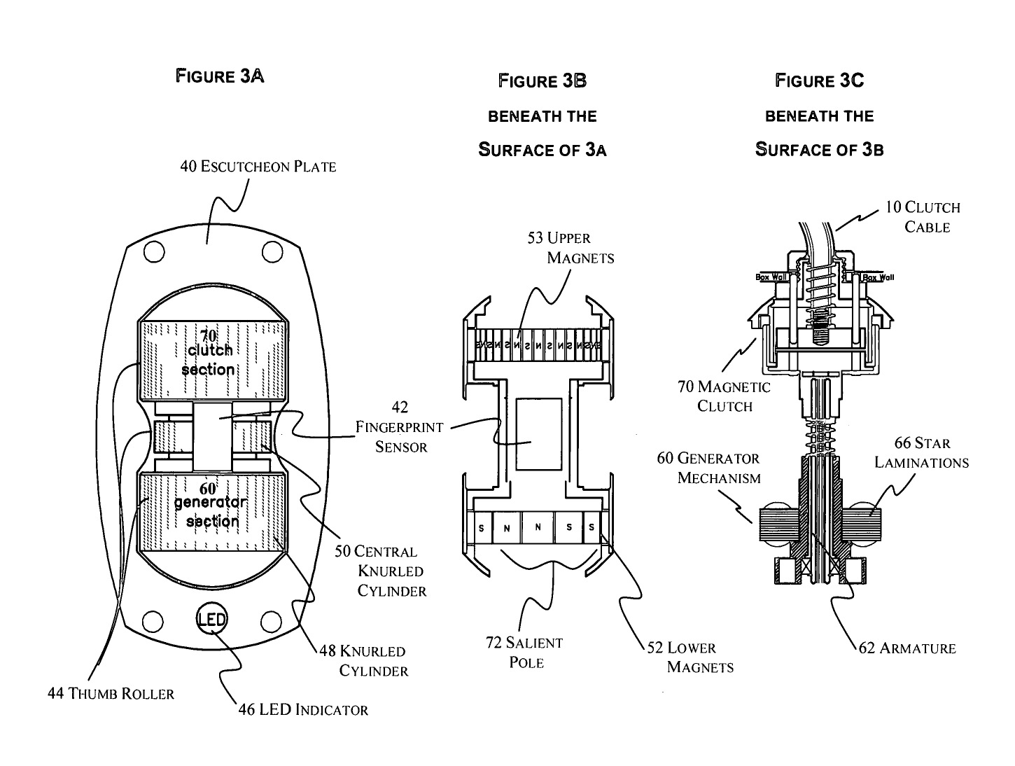

FIG. 3a depicts the escutcheon plate 40 of the unlocking mechanism 12, containing cutouts for a fingerprint sensor 42, thumb roller 44 and LED indicator 46. The fingerprint sensor 42 is a swipe sensor which eliminates possibilities of unauthorized access using a residual print image left on a sensor plate as the swiping wipes off/smears the residual print. The fingerprint sensor 42 is positioned to capture a gray scale image of the finger as a user moves it across the thumb roller 44.

The thumb roller 44 is positioned with the roller axis vertical on the side of the handbag 2 nearest to the closed end of the zipper 4, but can be located anywhere in any position about the handbag 2 for preferred design or functionality purposes. It passes through a tailored hole the escutcheon plate 40 which is dressed on the outside by a front bezel plate or material covering. In one embodiment, a matching flange internally captures the studs on the back side of a front bezel plate after they pass through the handbag material.

In one embodiment, the external plate contains holograms to thwart counterfeiting. In one embodiment, the thumb roller 44 is manufactured with knurls in an intricate pattern where the knurling pattern requires special castings or EDM to produce. In one embodiment, the facets of the knurling are trademarked designs, such as a manufacturer's logo.

The thumb roller 44 is manufactured in a spool arrangement with knurled cylinders 48 above and below the sensor 42, which contain a generator mechanism 60 and a magnetic clutch mechanism 70. The sensor 42 captures a fingerprint image, as a finger or thumb is passed over it from side to side. Multiple images in rapid succession are received by the sensor 42 as the finger or thumb advances across the sensor 42, to assemble an entire finger print image. The sensor 42 has a very shallow depth and is positioned above an additional centrally located knurled cylinder 50 with radius sufficiently small to pass under the sensor 42, and is operatively coupled to previously mentioned knurled cylinders 48 of the thumb roller 44. The knurled surfaces grip the thumb as it advances over the sensor 42 causing the roller 44 to turn as a side effect.

In one embodiment, the ends of the sensor 42 are supported between the outer races of two ball bearings located on either side of the center knurled ring. These outer races are also captured between an opening in the front of the thumb roller box (can) and a bearing cap mounted horizontally behind the roller by two screw standoffs. The bearing cap captures both bearings and has a cavity to allow the knurled center ring to turn freely under it. The opening in the thumb roller box is too narrow to allow the bearings at their widest point to pass through it, out the front. The bearing openings in the thumb roller box are tailored to match the bearing outer race curvature when the roller is inserted from the rear. In one embodiment, the edges of the bearing openings in the thumb roller box are radiused and deburred to allow a thin flexible circuit board to be passed into them from the side without violating minimum turn radius specs for the board or causing damage to the board material or circuit traces on them. The circuitry and support structure for the sensor consists of a flexible ribbon of thin (⅛ mm) printed circuit material (Kapton or similar), which has been bonded at one end to a standard FR4 fiberglass circuit board creating a stiff substrate for component mounting.

In one embodiment, the ribbon section is tailored to be inserted through the bearing opening while inserting the roller with holes matching the bearing cap screw standoffs allowing it to pass outboard of the bearing cap and turn up the side of the box to where it meets the stiff section of the board which is screw mounted to the bearing cap screw standoffs.

In one embodiment, the flexible ribbon emerges on the underside of the bearing cap next to the outer race of the two bearings and passes around them and back into the box to be captured on the opposite side between cap and box front wall by the other screw standoff. Across the front of the bearing outer races the ribbon splits into and upper and lower ribbon matching the bearings and at the midpoint a bridge between these two ribbons contains the footprints for soldering the sensor and local discrete bypass capacitors. The ribbon tension between the two bearing cap screws is what supports the sensor.

In one embodiment, to minimize the sensor width and exposed non-knurled surfaces, the sensor ends and an equivalent width of the bearing outer race are tucked inside the inner ends of the two outer knurled cylinders, which allows for the sensor and circuit board become part of the mechanical assembly at the time the roller is being pressed, screwed and snap ringed together.

FIG. 3b depicts a view of an arrangement of magnets 52, 53 beneath the surface of the knurled cylinders 48 of 3a. Internally the knurled cylinders 48 contain sections which function as mentioned below.

FIG. 3c depicts a view of an arrangement beneath the surface of the magnets 52, 53 depicted in 3b. The lower section is a generator mechanism 60 designed to produce approximately 1 watt of power at what would be considered a normal thumb swipe speed, which powers the control electronics without requiring battery or alternative source of current.

The upper section contains a latch trip mechanism known here as a magnetic clutch 70 with extremely low power requirements to match the low power available. In one embodiment, the upper section also contains an incremental position sensor which provides a means of measuring thumb motion other than just shooting pictures with a stop watch and trying to see what moved from one picture to the next, which is the way a print is normally received.

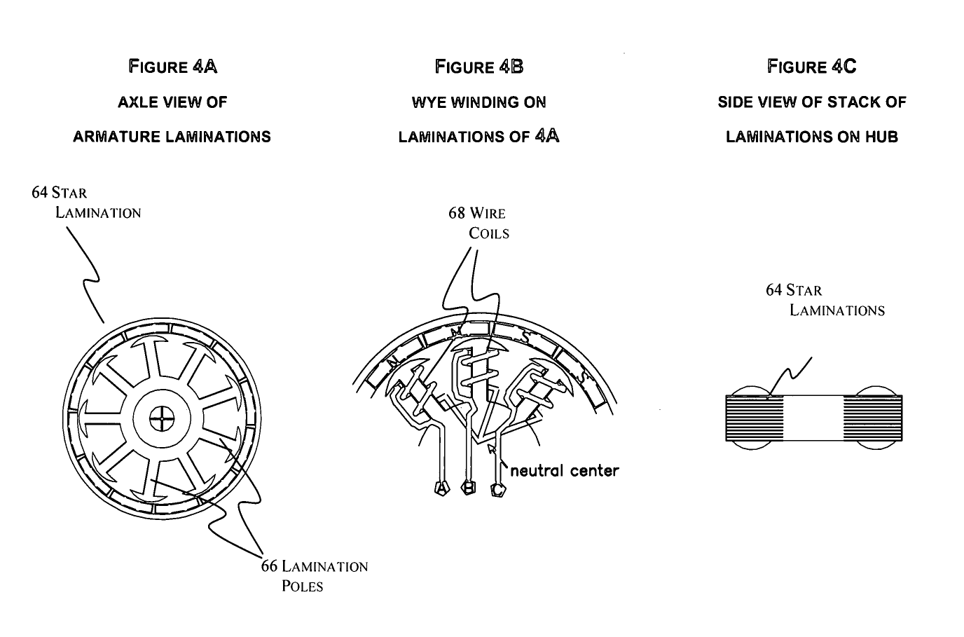

FIGS. 4a-c depict a view of the generator mechanism 60 beneath the surface of the lower magnets 52 depicted in 3b. As the roller 44 turns on its axis, it generates power to run the electronics of the unlocking mechanism 12. In one embodiment, the roller 44 is knurled in stainless steel because it is a good conductor for magnetic fields. The inside surface, as depicted in FIG. 3b, has twelve permanent magnets 52 bonded to it such that their polarity alternates every two magnets (i.e. NNSSNNSSNNSS). This makes a rotor with 6 poles or 3 cycles per rotation. An tube armature 62 is mounted beneath this section which has pressed on to it a stack of star like laminations 64 where there are nine poles 66 on the star. These poles 66 line up with the permanent magnets 52 on the rotor vertically. Axially there are 3 so called salient poles 72 per permanent magnet 52 North/South cycle. The poles 66 are wound with wire coils 68, which generate a voltage in the wire 68 when the rotor is turned. As the salient pole 72 goes over the lamination pole 66 the magnetic flux changes from North to South, the magnetic flux in the laminations will increase or decrease generating voltage in the winding 68. Since this repeats in 3 places around the generator mechanism 60, connecting every 3^{rd} pole 72 into the same winding 68 will produce three times the voltage.

The three winding voltages, relative to their position in the rotation, are generating a sinusoidal wave but the zero crossings are different by the time delay to make ⅓ rotation. In one embodiment, by connecting one end of each winding 68 to a common point the voltages will add with a 120 degree phase difference. If rectified with a diode bridge this will increase the output voltage by the square root of 3 or 73.2%.

Since the voltage based on a thumb swipe is expected to be small, all measures to improve it known by one skilled in the art as likely worthwhile are incorporated in the present invention and are incorporated into this patent. A normal rectifier diode drops 1 volt or more. In one embodiment, by using schottky diodes this can be decreased to 0.3 v. On a full wave bridge this is an increase in available voltage of 1.5 v. More elaborate synchronous detection techniques will net approximately another 0.3 volts or more. All designs which generate power by the motion of validating the fingerprint are deemed to be included in the present invention.

The output of the 3 phase bridge circuit is above the minimum input of a boost regulator which is typically 0.7 v to 1.0 v. Also typically once started the regulator will continue to work at the lower end of the range. Given the ripple nature of the generator output, the higher start voltage assures for a brief period each electrical cycle. In one embodiment, once started these switch mode regulators use a tiny inductor to produce any adjustable voltage from 2.5 v to 5.5 v. In one embodiment, the generator armature is coupled to a ribbon of thin flexible circuit off the main control electronics circuit board. In one embodiment, the electronics contain a unique serial number which can be associated to a user.

In one embodiment, a push button mechanism is implemented, where a fingerprint sensor 42 which receives a print as a whole is operatively coupled about the push button, and the push button is coupled to a mechanism which converts a linear force into rotary motion.

In one embodiment, the generator mechanism 60 is designed to convert and harness the motion of the slider 6 moving across the zipper 4 into current, where the internal stringer on each side of the zipper 4 is lined with the NSNSNS magnets 52, and the armature 62 with wire windings 68 is operatively coupled to the slider 6 and is positioned to ride the sides of the magnets 52 as if they were a track, where the voltage is stored for future use. In one embodiment, two horse shoe salient pole arrangements 72 positioned back to back like a sideways capital “H” are operatively fastened about the stringer 6 inside the handbag 2 parallel to the zipper teeth 4 and a magnet is attached to the base 7 of the slider adjacent to the catching mechanism 22, which moves across the horseshoe arrangements 72 as the slider 6 moves across the zipper 4. A flex printed circuit on the bag interior under the stringer sections passes through the magnet gaps and attaches to the ends of the zipper 4 to hold in out straight.

In one embodiment, a batten like stiffening bar sewed into the bag 2 lining outboard of the stringers is positioned to hold the zipper 4 and flex printed circuit out straight. The flex printed circuit is designed in a zigzag pattern matching magnet dimensions to the zigzags. Nylon rollers like a winch fairlead are positioned on the entries and exits of the magnet air gaps to keep from rubbing the copper traces off the flex printed circuit over time as it passed over the corners of the magnet into the air gap. For receiving and storing the power, a design is implemented consisting of compressing a spring, spinning up a flywheel, charging a capacitor, charging an inductor, charging a battery, or a combination thereof.

In one embodiment, the slider 6 is operatively designed to operate as a single unit, but is comprised of a first member and a second member, whereby the first member can be separated from the second member where the first member remains stationary to keep the zipper 4 locked, and the second member is free to slide up and down the range of the zipper 4 to recharge the power storage device before being secured back together with the first member as a single slider unit.

In one embodiment, a wake up device would be connected to the circuitry and power supply. In one embodiment, a user would activate the wake up device while swiping their finger across the sensor, which would activate a release of power from the stored power supply, to power the lock mechanism. In one embodiment, a solar panel would provide the power to validate a user and open the lock, whereby a solar cell about the handbag or container could charge a capacitor for a lock release about every 1-90 seconds.

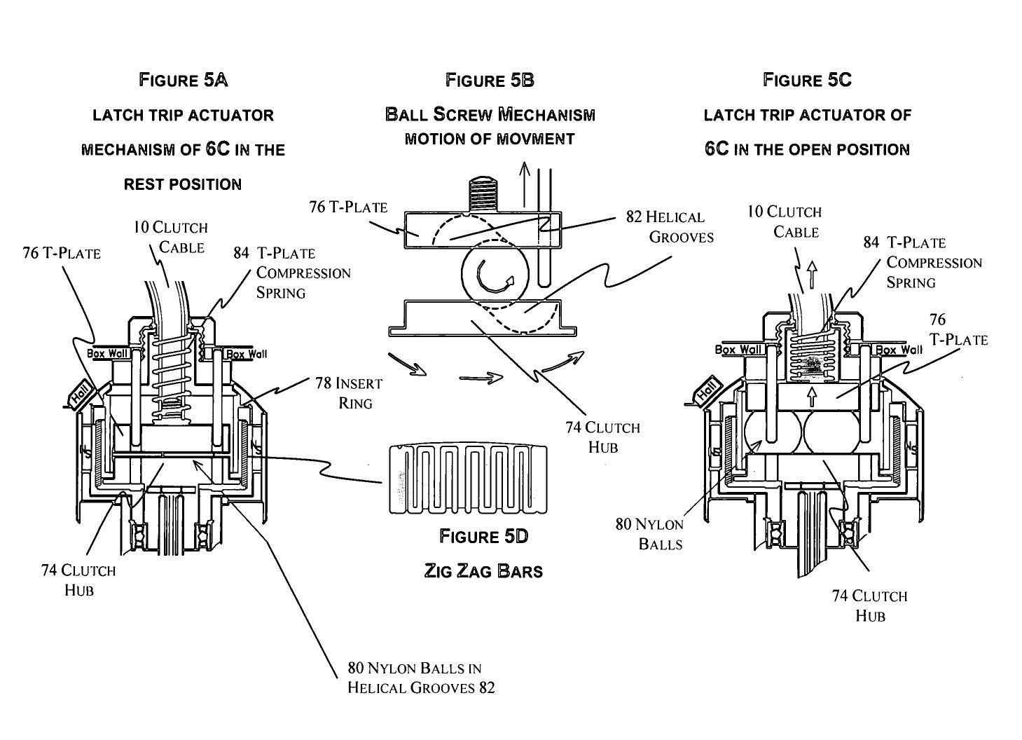

FIGS. 5a-c depict a view of the latch trip actuator also known as the a magnetic clutch 70 beneath the surface of the upper magnets 53 depicted in 3b. In one embodiment, the device operatively incorporates an eddy current clutch. In one embodiment, the magnetic clutch 70 shares the magnets 53 used by an encoder. In one embodiment, they are sensed by a dual Hall device on the main control electronics printed circuit board. In one embodiment, the encoder chip stands off the interior side of the board near the top end of the roller, where the smaller of two low reluctance inserts couples the magnet pole fields to the surface of the end cap.

The encoder chip has two Hall sensors precisely spaced by 1 mm to allow the same pole to be detected at 2 points 1 mm apart. By measuring the time between the two events the speed is accurately measured. Knowing the speed allows the time to swipe a stripe width to be computed and a timed interrupt can then be used to trigger the next stripe read. The speed setting can be continuously updated through out the read of a fingerprint. By monitoring which sensor changes to match the other versus changing to be the different from the other, the direction of rotation can be determined. This allows swipes in the wrong direction to be ignored. In one embodiment, a design is provided to allow for swipes in multiple directions.

The magnetic clutch 70 provides a mechanism which harnesses the rotational torque of a finger swipe on the roller 44 to actuate a clutch mechanism 70 and clutch cable 10 through a magnetic drag when a valid fingerprint is read. The clutch cable 10 is actuated by the torque of the thumb rather than the charge in the capacitor. The advantages are lower power of operation and because of the smaller power supply bypass capacitor, the processor will wake up quicker and get to work on the fingerprint quicker resulting in a more responsive lock operation.

The two primary elements of the clutch mechanism 70 are the magnetic clutch and a short ball screw mechanism FIG. 5B that is back driven to convert rotary thumb roller motion into linear latch trip actuation. The clutch portion uses a narrow axial gap in the roller 44 between the encoder magnets 53 and a low reluctance insert ring 78 connected to them by a nylon end cap. This gap is filled with a conductive ring supported by a clutch bearing and clutch hub/axle assembly. The ring 78 material is optimally selected to have very low resistance and no magnetic properties whatever. In one embodiment, the material used is a combination or a selected one of silver, copper and aluminum. The ring 78 is cut or etched into a zigzag pattern of bars having the same angular pitch as the encoder magnets 53. When these roller magnets 53 move relative to these ring bars 78 a voltage is generated which causes current to flow in the circuit. The current flow generates a magnetic field that attempts to lock to the motion of the roller encoder magnets 53. At one point around this zig zag ring 78, the circuit is cut open and a solid state switch is inserted. This allows the current flow to be disconnected for all cases except for a valid fingerprint match. The control circuit for the solid state switch is connected to the main control circuit board by the conductor in the clutch shaft hollow core and the shaft itself.

Once the torque of the roller 44 is coupled to the clutch hub 74, it magnetically drags the hub 74 to rotate which causes at least one nylon ball 80 in a helical slope-shaped groove 82 between the clutch hub 74 and the T-plate 76 to roll up the helical groove 82, pushing the T-plate 76 up which actuates the control rod 20, pushing a control rod 20 through a sheath 21 which is connected to the latch box assembly 8. The actuated control rod 20 unlocks the latch arm 26 as depicted in FIG. 2c. Once the torque from the thumb motion is drained, the t-plate compression spring 84 causes the t-plate 76 to retract which helps to recede the nylon balls 80 into the helical groove 82, as well as recede the control rod 20 in the latch box assembly 8.

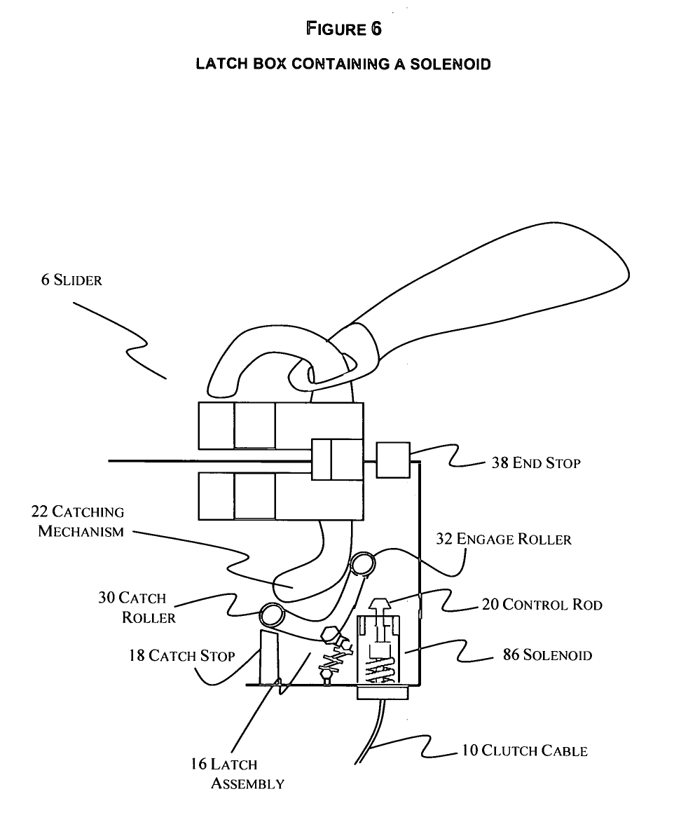

FIG. 6 depicts a side view of the zipper slider 6 approaching the latch box assembly 8, which contains a latch assembly 16, catch stop 18, and a solenoid 86. In this embodiment of the present invention the latch trip actuator is a large input capacitor associated to the electronics and a solenoid mechanism 86, where the solenoid mechanism 86 is contained in the latch box assembly 8, however can be located remotely about the handbag 2. Upon receiving a matching fingerprint, the solenoid mechanism 86 is simply pulsed on briefly and the control rod 20 is actuated. In one embodiment, the dual cylinders 48 of the roller mechanism 44 are replaced by a single roller containing the generator mechanism 60 and the sensor 42 is operatively positioned so a user swipes the sensor 42 and initiates the roller mechanism 44 in a single motion.

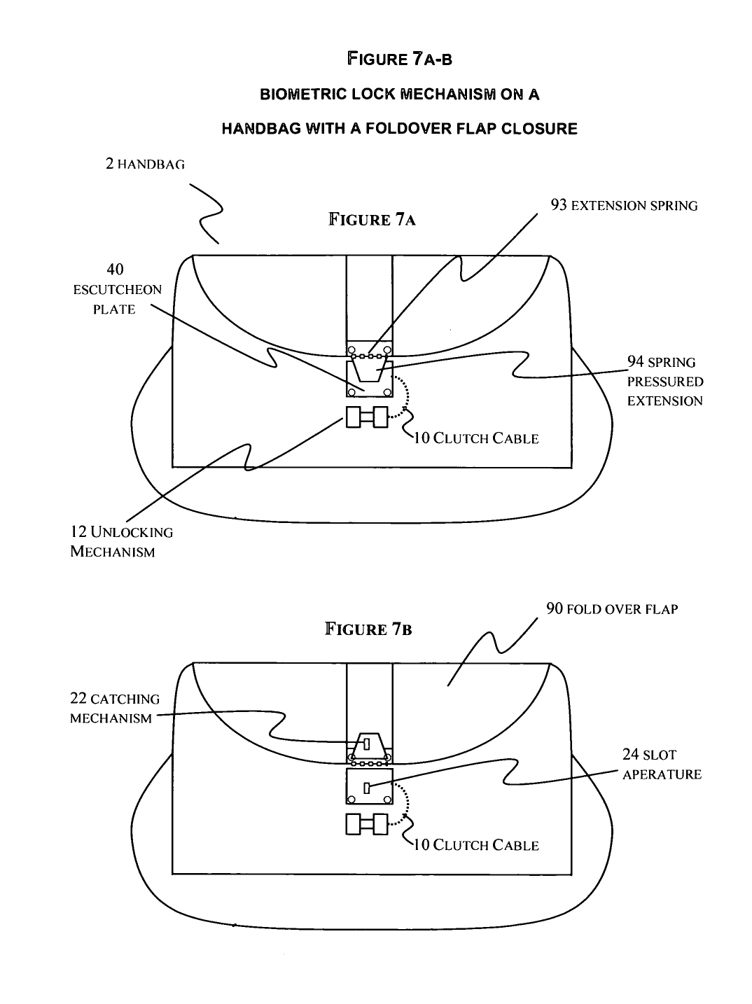

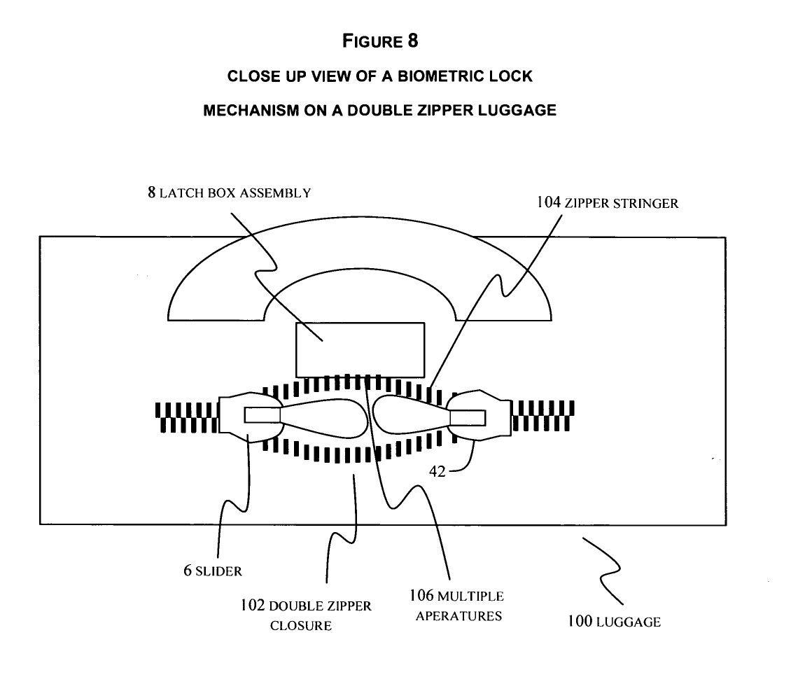

FIGS. 7a-7b. Depict an aerial view of a handbag 2 with a fold over flap closure 90, in one embodiment of the present invention, but could also be applied to a briefcase or any container with a fold over closure, such as a metal clip board container to protect secure documents, or secure shipping or storage containers. The handbag containing a fold over flap 90, including a catching mechanism 22 on a spring pressured extension 94, pressured away from the escutcheon plate 40 by an extension spring 93 or similar pressurable means, which is operatively positioned to secure an aperture in the handbag 2. In the present embodiment, the latch box assembly 8 is located in the center wall of the bag 2 beneath the escutcheon plate 40, and contains an slot aperture 24 which receives the catching mechanism 22 of the spring pressured extension 94 when a user inserts the catching mechanism 22 into the slot aperture 24. In one embodiment, the escutcheon plate 40 or the spring pressured extension 94 contains a magnet to assist the user with closing alignment. In one embodiment, the catching mechanism 22 and the spring pressured extension 94 are pressured in the opposite direction of the latch box assembly 8, where the extension spring 93 is actuated when the catching mechanism 22 is in the locked position, which pulls the catching mechanism 22 from the latch box assembly 8 when released. A clutch cable 10 connects the latch box assembly 8 to an unlocking mechanism 12 located about the handbag 2.

FIG. 8. Depicts an aerial view of a luggage 100 with a double zipper closure 102, in one embodiment of the present invention, but could be applied to a computer bag or any container with a dual zipper closure 102. In this embodiment, the latch box assembly 8 is operatively positioned at a fixed midpoint about the slider stringer 104, containing multiple apertures 106 for receiving the catching mechanisms 22 operatively positioned on the base of the sliders 6, as depicted in prior drawings. In one embodiment, the latch box assembly 8 is adjustable and can be relocated along the slider stringer 104 by a user. In one embodiment, the latch box assembly 8 contains multiple catching mechanisms 22 for grabbing apertures located on the zipper sliders 6. An unlocking mechanism 12 is located about the luggage 100 as in previously described embodiments, and is operatively connected to the latch box assembly 8. In one embodiment, the unlocking mechanism 12 and the latch box assembly 8 provides for releasing both sliders 6 simultaneously.

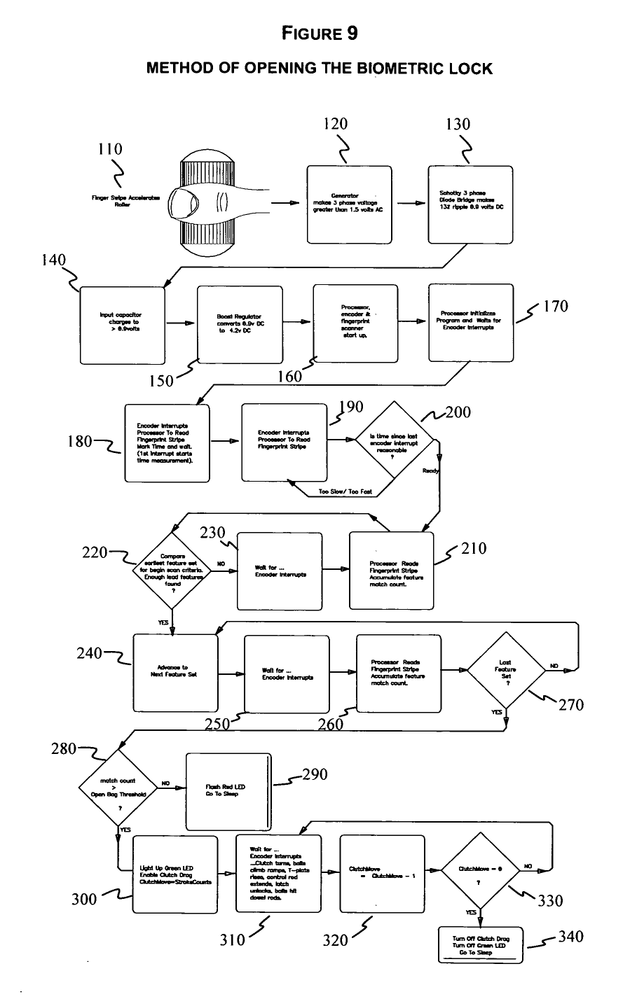

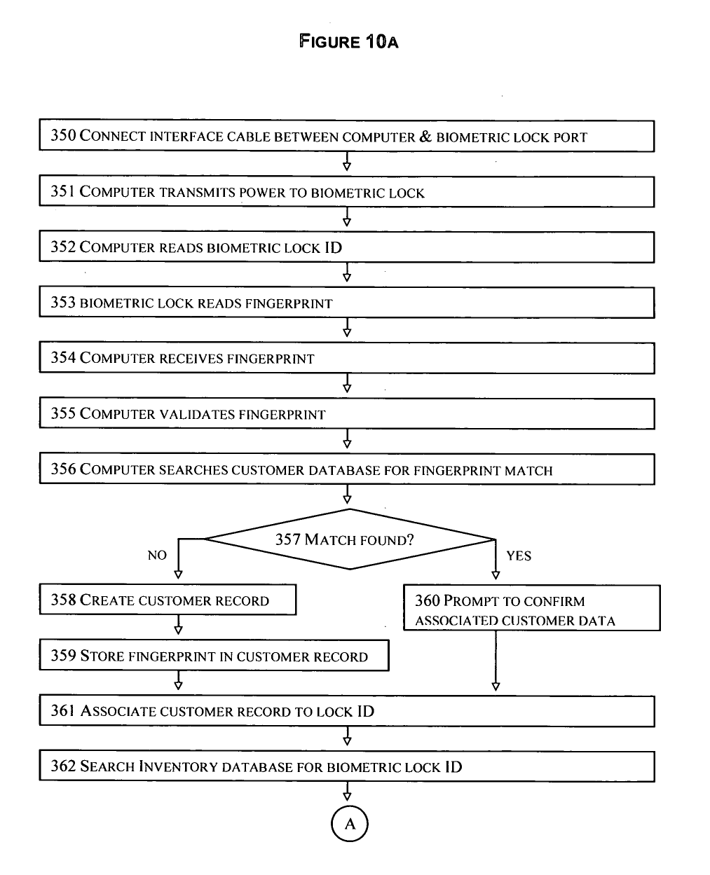

FIG. 9. Depicts a method of opening a biometric lock. In this embodiment, the container which contains the biometric lock of the present invention is in a locked position by a user pulling the zipper slider to a closed position, thereby securing the catching mechanism of the slider into the latch box. In one embodiment, the method is used with a container which contains a fold over flap as depicted in FIGS. 7A-B.

To activate the unlocking mechanism, a user swipes a finger across the sensor and simultaneously accelerates the roller in the same stroke 110. In one embodiment, the lock is opened through multiple strokes by the user. The acceleration of the roller causes the generator mechanism of the roller to make a 3 phase voltage greater than 1.5 volts AC 120. In one embodiment, the voltage generated is less than 1.5 volts AC, and is amplified. A Schotky 3 phase diode bridge makes 13% ripple 0.9 volts DC 130. An input capacitor charges to greater than 0.9 volts 140. A boost regulator converts 0.9 v DC to 4.2 v DC 150, which provides for the processor, encoder and fingerprint sensor to start up 160. The processor initializes a stored program and waits for encoder interrupts 170. The encoder interrupts the processor to read the fingerprint stripe, mark time and wait (1^{st} interrupt starts time measurement) 180. The encoder interrupts the processor to read the fingerprint stripe a second time 190. The time since the last encoder interrupt is checked 200. If the time since the last encoder interrupt is not reasonable, the encoder interrupts the processor to read the fingerprint stripe again 190. If the time since the last encoder interrupt is reasonable, the processor reads the fingerprint stripe and accumulates a feature match count 210. The processor compares the feature set for begin scan criteria 220. If enough lead features are not found, the processor waits for another encoder interrupt 230, then again reads fingerprint stripe and accumulates feature match count 210. If enough lead features are found, the processor advances to the next feature set 240, waits for encoder interrupt 250, reads fingerprint stripe and accumulates the feature match count 260. The feature set is checked to determine if it is the last feature set 270. If it is not the last feature set, the processor continues to advance to the next feature set 240, waits for encoder interrupt 250, reads fingerprint stripe and accumulates the feature match count 260. If it is the last feature set, a determination is made is there is a sufficient match count 280. If feature match count determines that the fingerprint of the user is not the same as at least one stored in memory, a signal is sent to an indicator, such as a red LED, and the device goes to sleep 290. In one embodiment, the LED, is replaced with a plastic optical fiber transmitter LED which has a hole in the end to fit 1 mm plastic fiber, which is visible as a normal LED with no fiber present. When a valid print is detected it flashes with a recognizable pattern. When a fingerprint swiped does not match one on file it transmits a serial bit stream which represents an ID code unique to the handbag.

If it is the last feature set, and the feature match count determines that the fingerprint of the user is the same as at least one stored in memory, a signal is sent to an indicator, such as a green LED, and the device enables the latch actuator mechanism to rotate with the magnets of the roller by way of a magnetic drag 300. As the latch actuator mechanism rotates, the balls climb the internal slopes, which push the upper T-plate of the latch actuator mechanism upwards, which extends the control rod to pivot the latch arm in the latch box, which releases the catching mechanism of the slider 310. In one embodiment, the catching mechanism is on a spring pressured apparatus on a fold over flap. The release of the catching mechanism allows the spring to contract, therefore pulling the catching mechanism away from the latch box. The power is drained 320, 330, the latch actuator mechanism and control rod return to their default positions and the device goes to sleep 340.

In one embodiment, if it is the last feature set, and the feature match count determines that the fingerprint of the user is the same as at least one stored in memory, a signal is sent to an indicator, such as a green LED, and to a solenoid which actuates and pivots the latch arm in the latch box, which releases the catching mechanism of the slider. In one embodiment, the catching mechanism is on a spring pressured apparatus on a fold over flap. The release of the catching mechanism allows the spring to contract, therefore pulling the catching mechanism away from the latch box. The power is drained, the solenoid mechanism returns to its default position and the device goes to sleep.

In one embodiment, if it is the last feature set, and it is determined that there is no fingerprint stored in memory, a different signal is sent to an indicator, such as a flashing or solid red LED to notify a user the lock is unprotected, and the device continues to unlock in one of the methods previously described.

In one embodiment, a user swipes a finger across the sensor and simultaneously accelerates the roller in the same stroke. The roller is mechanically and operatively connected to the latch release mechanism, where the acceleration of the roller causes the latch release mechanism to release the catching mechanism of the slider with no user identification or discrimination. In one embodiment, the acceleration of the roller activates a signal to be sent to an indicator, such as a green LED, for product imitation purposes.

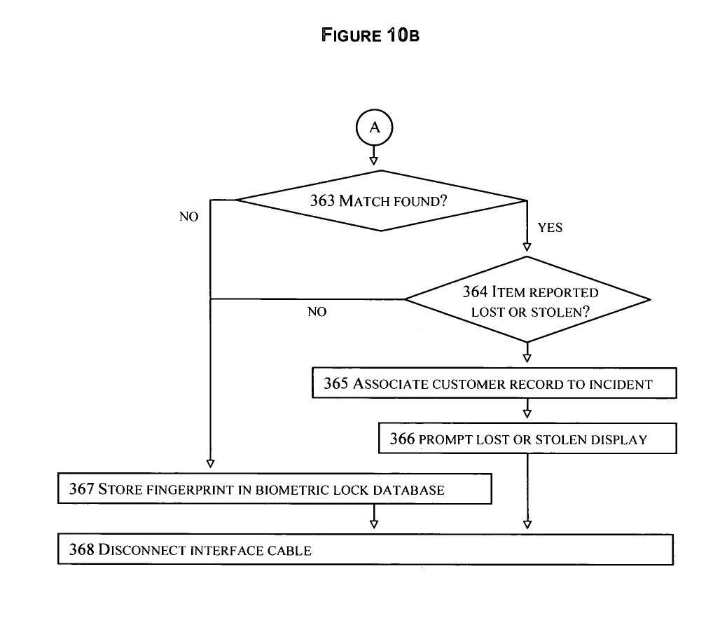

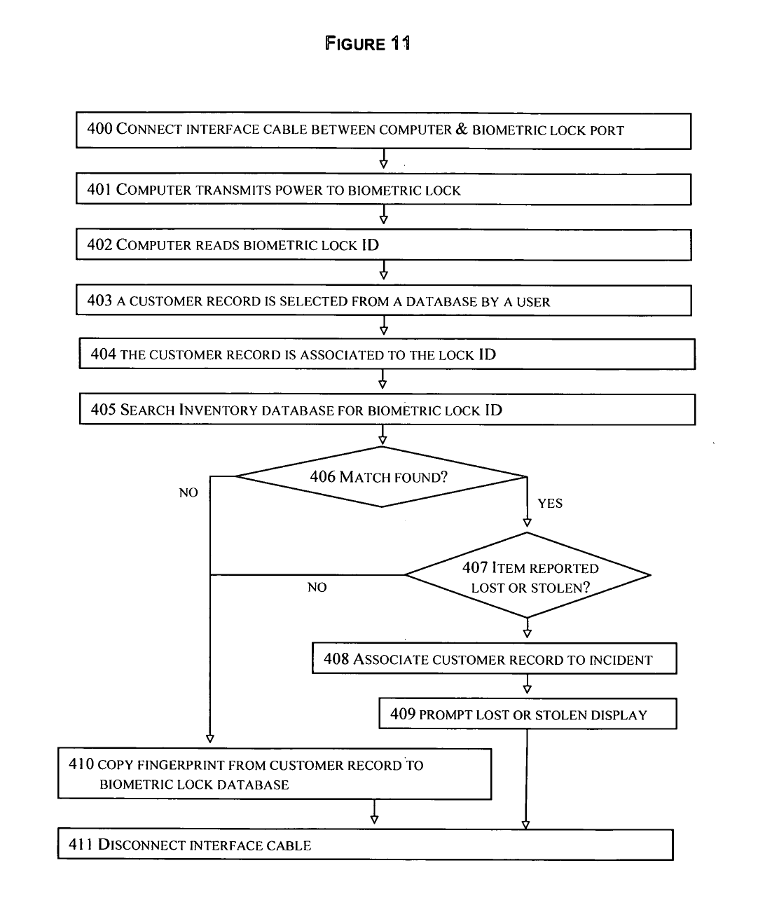

FIGS. 10a-b. Depict a method of enrolling a user's fingerprint into the biometric lock. Enrollment typically occurs after a purchase when the new user is loading their personal biometric data into the control electronics. When this occurs, communication needs to last longer than just the time to open the lock. An interface cable is connected 350 between a computer and the control electronics of the lock mechanism. In one embodiment, the interface cable is a USB cable and is connected through a USB port operatively coupled to the control electronics, though any connection port protocol may be employed. The USB cable uses a 4 wire connection where 2 wires are signal and two are power which transmits 351 power to the control electronics of the lock mechanism. This power is directly 4.2 v to 5.5 v but the host has the ability to turn it on or off. If the driver wants it on, the current available for a host powered device is 500 ma which is more than 3 times the expected worst case load. The power can be fed through the same regulator that the generator uses except for providing separate diodes to prevent the USB bus from trying to drive the generator windings.

The computer reads 352 the biometric lock's serial ID. The biometric lock reads 353 the fingerprint of a user by the user applying their fingerprint to the sensor of the biometric lock. The computer receives 354 the fingerprint, and then validates 355 the fingerprint when the user inputs the print a multiple of times. The computer searches 356 a customer database for a fingerprint match, and determines 357 if the print matches one in a pre-existing database. As the customer is supposedly a new customer, a match is not expected, but it is possible the customer does not recall a previous purchase or scan for setting up a customer. If there is no match, a customer record is created 358. The fingerprint is stored 359 in the customer record and the biometric lock database. If there is a match, the computer prompts 360 a user to confirm the data in the associated customer record.

The lock serial ID is associated 361 to the customer record. Following, an inventory database is searched 362 for the lock's serial ID, and a determination 363 is made if there is a match. The serial ID provides the basis for tracking an inventory item through its life cycle. In one embodiment, a retailer or manufacturer offers trade-in and resale services for its customers associated to this lifecycle tracking technology. If a match is not found, the fingerprint is stored 367 in the database of the biometric lock mechanism. If a match is found, a determination 364 of whether the item has been reported lost or stolen is made. If the item has not been reported lost or stolen the fingerprint is stored 367 in the database of the biometric lock mechanism, and the interface cable is disconnected 368 completing the process. If the item has been reported lost or stolen the incident is associated 365 to the customer record, and a lost or stolen display is prompted 366, indicating further action is required by an employee. The interface cable is disconnected 368 completing the process.

In one embodiment, a user is provided with software and a interface cable to enroll their fingerprint on their own. In one embodiment, a user is provided with software and an interface cable, which allows for an override system where if a user's lock malfunctions or the user's fingerprint is unreadable, a unique code or password applied into the software will allow a user to open the lock if connected to the computer with the interface cable. In one embodiment, all data stored in the database of the lock is not retrievable unless by specialized software designed for this purpose. In one embodiment, a user's data is erasable from the lock database.

FIG. 11. Depicts a method for enrolling a fingerprint for a new item by an established customer. An interface cable is connected 400 between a computer and the control electronics of the lock mechanism. The computer transmits 401 power to the biometric lock. The computer reads 402 the biometric lock's serial ID. A customer's identification is verified by a user and their customer record is selected 403 from a database. In one embodiment, the user is identified by applying their fingerprint to the sensor of the biometric lock. The computer prompts to confirm the data in the associated customer record and the fingerprint is copied from the customer's record and is stored in the biometric lock database.

Then, the lock serial ID is associated 404 to the customer record. Following, an inventory database is searched 405 for the lock's serial ID, and a determination 406 is made if there is a match. If a match is not found, the fingerprint is copied 410 from the customer record to the database of the biometric lock mechanism, and the interface cable is disconnected 411 completing the process. If a match is found, a determination 407 of whether the item has been reported lost or stolen is made. If the item has not been reported lost or stolen the fingerprint is copied 410 from the customer record to the database of the biometric lock mechanism, and the interface cable is disconnected 411 completing the process. If the item has been reported lost or stolen the incident is associated 408 to the customer record, and a lost or stolen display is prompted 409, indicating further action is required by an employee. The interface cable is disconnected 411 completing the process.

The secure storage of customer fingerprints and the means to copy a stored print from a customer record to an item containing the lock without the print owner being present allows for tremendous marketing opportunities and is incorporated into the present invention. In one embodiment, the customer purchases the item over the phone, internet, mail or in a non-present manner and the item would be shipped to the consumer with their fingerprint installed. In one embodiment, a customer's fingerprint is stored in the item before a purchase is made and is presented to the customer for their purchase consideration. In one embodiment a customer record is randomly selected from the database and the fingerprint is copied from the customer record to the database of the biometric lock, where existing customers are notified and prompted to come to the retailer to insert their fingerprint; a matching print opens the lock and the lucky print owner receives the item for free, aka a “King Arthur” promotion.

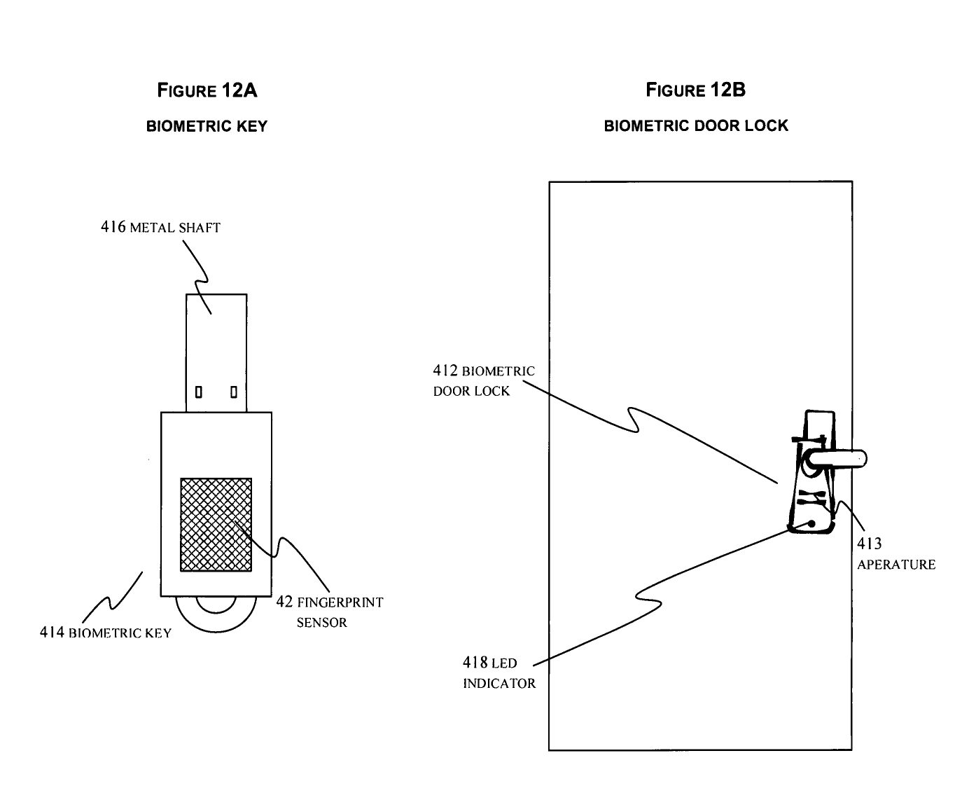

FIGS. 12a-b Depict the biometric lock mechanism in multiple components, comprising a locking mechanism and a biometric key 414. This embodiment of the present invention provides a biometric door lock 412, however can also be used in securing other items that are typically in a fixed or permanent location. Biometric door locks are known in the prior art, however the present embodiment is an improvement as it provides an additional level of security, as a biometric key 414 is required before a user can even attempt to unlock the device. Additionally, the biometric keys can be manufactured in a generic manner and are useless to a user whose print data is not pre-stored and accessible to the locking mechanism.

In the present embodiment, the biometric lock is comprised of a first member and a second member, the first member being a key mechanism 414 containing a fingerprint sensor 42. The key has a rectangular shape with a shaft 416 which extends outward. In one embodiment, the key is credit card shaped with a fingerprint sensor 42 about the card, and metal plates on one side of the card which transport the fingerprint data when inserted into the second member.

The second member is the locking mechanism 412 and is permanently fastened to a fixed item, such as a door, and contains a power source, processor or other type of operating device, a storage means, an aperture 413 which receives the metal shaft 416 of the biometric key 414, an encoder, electronics which power the key sensor and allow for the transfer of print data to the processor, an external LED indicator, a locking mechanism, and a motor for operating the locking mechanism. In one embodiment, the power source is received from a permanent source, such as a building's electrical current, and is in an always on status. In one embodiment, the power source is the roller generator mechanism of FIGS. 4a-c and the motor is replaced by the magnetic clutch of FIGS. 5a-c.

To unlock the device, a user inserts the metal shaft 416 of the biometric key 414 into the aperture 413 of the lock mechanism, and the key receives current which provides for the sensor 42 to operate. In one embodiment, the key contains an indicator to assure the user it is properly powered and ready to receive the finger print. In one embodiment, the indicator 418 of the lock mechanism indicates that the key 414 is properly powered and ready to receive the finger print. The user swipes a fingerprint across the sensor 42, and the fingerprint data is received by the processor. The processor initializes a stored program and waits for encoder interrupts. The encoder interrupts the processor to read the fingerprint stripe, mark time and wait (1^{st} interrupt starts time measurement). The encoder interrupts the processor to read the fingerprint stripe a second time. If the time since the last encoder interrupt is not reasonable, the encoder interrupts the processor to read the fingerprint stripe again. If the time since the last encoder interrupt is reasonable, the processor reads the fingerprint stripe and accumulates a feature match count. The processor compares the feature set for begin scan criteria. If enough lead features are not found, the processor waits for another encoder interrupt, then again reads fingerprint stripe and accumulates feature match count. If enough lead features are found, the processor advances to the next feature set, waits for encoder interrupt, reads fingerprint stripe and accumulates the feature match count. If it is not the last feature set, the processor continues to advance to the next feature set, waits for encoder interrupt, reads fingerprint stripe and accumulates the feature match count. If it is the last feature set, and the feature match count determines that the fingerprint of the user is not the same as at least one stored in memory, a signal is sent to the indicator 418, such as a red LED, and the device goes to sleep.

In one embodiment, the unauthorized fingerprint is recorded to a permanent database and is associated to the day, time, and location of the opening attempt for security purposes. In one embodiment, a database is scanned to identify the owner of the unauthorized fingerprint, and the identifying data is associated to the recorded opening attempt for security purposes.

If it is the last feature set, and the feature match count determines that the fingerprint of the user is the same as at least one stored in memory, a signal is sent to the indicator 418, such as a green LED, and the device enables the motor to unlock the locking mechanism. In one embodiment, the authorized fingerprint is recorded to a permanent database and is associated to the day, time, print owner and location of the opening attempt for security purposes.

In one embodiment, the sensor 42 receives the entire fingerprint without being swiped, but rather applied to the sensor as a whole, and the processor receives the print as a whole. In one embodiment, the roller/generator mechanism is a door knob where the sensor is coupled to the knob and is positioned whereby a user's finger can be read while their hand is applied to the door knob. As the user rotates the door knob or moves a non-rotatable door knob, power is generated, their identity is confirmed, and the lock opens or remains locked based on their identity outcome. In one embodiment, the print data is stored on a permanent server, accessible through a network which is operatively connected to one or multiple locks in a location or vicinity, where an administrator has control to add or delete fingerprints to the database.

One embodiment of the present invention is an improvement of the prior art; the unlocking mechanism 12 of the present invention used in a biometric padlock. This embodiment of the present invention incorporates the scanner 42, the roller/generator mechanism of FIGS. 4a-c and the magnetic clutch mechanism of FIGS. 5a-c into the invention of patent no. U.S. Pat. No. 6,401,510 issued Jun. 11, 2002 by KAJUCH et al. titled LOCK CONSTRUCTION.

In the issued patent, KAJUCH teaches of a lock body defining an interior cavity and a shackle that is releasably received in the interior cavity, where a locking mechanism is disposed within the interior cavity of the lock and comprises rotatable first and second members and a motor is included to rotate said second member and thereby rotate the first member to secure and release the shackle between the locked and unlocked positions.

In column 4 lines 23-30, KAJUCH teaches as follows:

“The locking mechanism is further connected to a motor for operating the locking mechanism. A power source is used to drive the motor to operate the locking mechanism. In the preferred embodiment, a DC motor is used as the motor, and the power source is in the form of a battery, preferably a conventional 3V-lithium battery.”

The disadvantage of this design is the locking mechanism is dependent upon a battery which can die and render the lock inoperable unless the battery is replaced. A user could be placed in a difficult predicament if they need access to an item being secured by the lock and the battery dies. Furthermore, the consumption of batteries creates unnecessary hazardous waste.

The fingerprint sensor, roller generator mechanism and magnetic clutch mechanism of the present invention provide an improved means to identify a user and rotate the worm drive and locking cam, therefore releasing the shackle without being dependent on an external or temporary power source. This design also eliminates the need for the DC motor, as the worm drive and locking cam are rotated by the rotation of the magnetic clutch powered by the torque of the thumb rather than the DC motor. Additional advantages are lower power of operation and because of the smaller power supply bypass capacitor, the processor will wake up quicker and begin to process the fingerprint quicker resulting in a more responsive lock operation.

Also in KAJUCH's design, the worm wheel must turn a specific amount in each direction to lock or unlock, which may require a position encoder. In one embodiment of the present improvement, an improved design which manually latches and unlatches after a minimum travel is implemented without the encoder, reducing cost and complexity.

The foregoing is considered as illustrative only of the principles of the invention. Further, since numerous modifications and changes will readily occur to those skilled in the art, it is not desired to limit the invention to the exact operation shown and described, and accordingly, all suitable modifications and equivalents may be resorted to, falling within the scope of the invention. It will be appreciated that not every implementation will necessarily embody all or even most of the specific embodiments, details and extensions discussed above in relation to the basic system. However, the system is described in the above manner to reduce the need for external reference when attempting to understand the context in which the alternative embodiments and aspects of the present invention operate.

Should any provision of this patent be void or unenforceable for any reason, such provision shall be deemed omitted and this patent with such provision omitted shall remain in full force and effect.

The following is claimed:

1. A biometric lock device whereby power is generated by the motion of validating a fingerprint.

2. A dual-powered electronic lock.
